(19) United States
(12) Patent Application Publication
(10) Pub. No.: US 2022/0397654 A1
(43) Pub. Date: Dec. 15, 2022

(54) LIDAR SENSOR INCLUDING CONTROL DETECTOR

(71) Applicant: Robert Bosch GmbH, Stuttgart (DE)

(72) Inventor: Johannes Richter, Ludwigsburg (DE)

(21) Appl. No.: 17/642,879

(22) PCT Filed: Oct. 23, 2020
(86) PCT No.: PCT/EP2020/079911

§ 371 Date: Mar. 14, 2022

(30) Foreign Application Priority Data
Oct. 31, 2019 (DE) 10 2019 216 811.6

(51) Int. Cl. G01S 7/497; G01S 7/481

(52) U.S. Cl. CPC G01S 7/4972; G01S 7/4817

(57) ABSTRACT

A LIDAR sensor for sampling a sampling range, including a radiation source for generating beams and a detector for detecting beams, and a immovable, rotatable or swivelable mirror for deflecting the generated beams at a mirror surface of the mirror into the sampling range or for deflecting beams, reflected or backscattered from the sampling range, to the detector. The mirror is a semitransparent mirror, and the LIDAR sensor includes a control detector for receiving beams that are transmitted through the mirror. A method for checking a functionality of a LIDAR sensor and a control unit are provided. Deviations/discrepancies in the optical characteristic of the generated beams are ascertained, a position on a detector surface of the control detector or on a mirror surface, and/or a radiation intensity. Based on the optical properties of the mirror, the evaluation of the transmitted beams may be transferred or applied to the generated beams.

### FIELD

The present invention relates to a LIDAR sensor for sampling a sampling range, a method for checking a functionality of an emitting unit, and a control unit.

### BACKGROUND INFORMATION

Automatedly operable vehicles and driving functions are becoming increasingly important in public road traffic. Sensors such as camera sensors, radar sensors, and LIDAR sensors are necessary for technically implementing such vehicles and driving functions.

LIDAR sensors generate electromagnetic beams, for example laser beams, and utilize these beams for sampling a sampling range. Distances between the LIDAR sensor and objects in the sampling range may be ascertained based on a time-of-flight analysis. However, the generated beams may be harmful to the human eye, so that it must be ensured that the generated beam power or beam intensity remains below allowable limits.

In addition, materials such as adhesives, glasses, and mountings may structurally degrade with increasing periods of use of the LIDAR sensor, due to aging phenomena. Thus, the shape of the emitted beams as well as the orientation of the emitted beams may deviate from the planned specifications. As a result, the emitted beams may also be more strongly focused. The beam power of the emitted beams may thus be harmful to the human eye. A different orientation of the emitted beams may also adversely affect the accuracy of the LIDAR sensor.

### SUMMARY

An object of the present invention is to provide a method and an emitting unit that may ensure safe and reliable operation of a LIDAR device.

This object may be achieved by example embodiments of the present invention. Advantageous embodiments of the present invention are disclosed herein.

According to one aspect of the present invention, a LIDAR sensor for sampling a sampling range is provided. The LIDAR sensor includes an emitting unit and a receiving unit. Depending on the design of the LIDAR sensor, the emitting unit and the receiving unit may share at least a portion of the optical components with one another. For this purpose, for example at least one immovable, rotatable or swivelable mirror may be jointly used by the emitting unit and the receiving unit.

The emitting unit of the LIDAR sensor includes a beam source for generating beams. The receiving unit includes a detector for detecting beams.

The immovable, rotatable or swivelable mirror is used for deflecting the beams, generated by the beam source, at a mirror surface of the mirror into the sampling range or for deflecting beams, reflected or backscattered from the sampling range, to the detector.

According to the present invention, the at least one mirror is designed as a semitransparent mirror, the LIDAR sensor including a control detector for receiving beams that are transmitted through the mirror.

The mirror may be designed as a semitransparent or partially transmitting mirror which may reflect, for example, more than 90% of the generated beams. The beams transmitted through the mirror may be received by the control detector and subsequently evaluated by a control unit. The mirror may thus allow only a minor portion of the generated beams to pass through to the control detector.

The at least one mirror may be formed, for example, from a metal layer that is applied to a transparent substrate. The substrate may be glass or a plastic, for example. The metal layer may have a layer thickness of 10 nm to 100 nm, and may be made of silver or aluminum, for example. The metal layer may reflect the majority of the generated beams, it being possible for a portion of the beams to be transmitted through the metal layer due to the high radiation intensity. According to one alternative or additional specific embodiment, the at least one mirror may be designed as a dielectric mirror.

The control detector used may be designed as a flat detector. For example, the control detector may be designed as a CCD sensor, CMOS sensor, APD array, SPAD array, and the like. As the result of situating the control detector behind the mirror, the transmitted beams may directly expose the control detector, and the resulting measured data may be evaluated.

The control detector may preferably be situated behind the last mirror in the emitting unit, after which the generated beams leave the emitting unit and pass into the sampling range.

Due to the use of the control detector, it may be ensured that the generated beams of the emitting unit also meet regulatory requirements for eye safety in the future. In particular, the control detector enables early recognition of optical misalignments or a change in the radiation power of the generated beams.

Analogously to the emitting unit, the control detector may also be used in a receiving unit. For this purpose, the control detector may be situated at a first mirror in the irradiation direction of the reflected beams, or at a last mirror with respect to the detector of the receiving unit.

By use of the emitting unit according to the present invention, LIDAR sensors may be operated over the long term with increased safety for the human eye. Initiation of further measures may be made possible based on the continuous or intermittent monitoring of a spatial beam shape or a beam cross section, a radiation power, and an orientation of a point of incidence on the mirror. Such measures may include outputting error messages or warnings, or a recalibration.

The long-term functional reliability of the emitting unit may be achieved with minimal costs by using standard components for the control detector.

According to one specific embodiment of the present invention, the control detector is connected to a control unit in a data-conveying manner. The measured data ascertained by the control detector may thus be received and evaluated by the control unit. The control unit may already be integrated into the emitting unit, or may be designed as an external control unit. For example, the control unit may be configured to activate the at least one beam source and/or to evaluate measured data of a receiving unit of a LIDAR sensor.

By evaluation of the measured data of the control detector, the control unit may automatedly recognize changes in the beam characteristic of the generated beams and initiate countermeasures such as recalibrations or maintenance activities. The initiation of recalibration is not limited to the emitting unit. In particular, a recalibration of an entire LIDAR sensor may be carried out.

According to a further specific embodiment of the present invention, the control detector is situated at a rear surface of the mirror facing away from the mirror surface or is spaced apart from the rear surface. The control detector may be positioned directly at the rear surface of the mirror. In particular, the control detector may form the rear surface of the semitransparent mirror. According to a further embodiment, the control detector may be spaced apart from the rear side. The control detector may be deflected or rotated together with the mirror.

According to a further exemplary embodiment of the present invention, the control detector, which is spaced apart from the rear surface of the mirror, is stationarily mounted. Due to a stationary mounting of the control detector, the control detector may be positioned within the emitting unit and/or the receiving unit so that it is immovable relative to the mirror. For example, the control detector may be situated outside a rotatable or swivelable plate of the LIDAR sensor. Alternatively, the control detector may be spaced apart from the swivelable mirror. A data-conveying connection between the control detector and the control unit may be implemented technically in a particularly simple manner by such a stationary mounting of the control detector. A rotor or rotatable plate of the LIDAR sensor may manage passively or without electrically conductive connections.

According to a further specific embodiment of the present invention, the control detector is configured to ascertain measured data via a beam shape, a position on a detector surface, and/or a radiation intensity of the beams transmitted through the mirror. Due to a flat design of the control detector, shapes of the beam cross section, dimensions, and the point of incidence of the transmitted beams may be determined by evaluating measured data of the control detector. The ascertained values may also be compared to intended or planned values in order to identify discrepancies or deviations. Misalignments or signs of aging of materials of the LIDAR sensor may thus be detected.

According to a further exemplary embodiment of the present invention, the control detector is configured to record the measured data over a period of time in a time-resolved manner. Optical properties of the generated beams or of the beams that are backscattered from the sampling range may be observed over a period of time by use of this measure. Such monitoring of the radiation characteristic in a time-resolved manner may take place, for example, via multiple transmitted beams or beam pulses.

The properties, for example the position of incidence on a detector surface, dimensions, beam shape, and intensity, of each received transmitted beam may preferably be received and evaluated. Individual or periodic fluctuations in the properties may thus also be established by evaluating the measured data of the control detector, as the result of which errors in an activation of the beam source, or of the beam source, are also detectable.

According to a further aspect of the present invention of the present invention, a method for checking a functionality of a LIDAR sensor by a control unit is provided.

In one step, measured data, ascertained by a control detector, of beams transmitted by a semitransparent mirror are received.

The received measured data are evaluated by the control unit, a beam shape, at least one dimension, a position on a detector surface of the control detector or on a mirror surface, and/or a radiation intensity of the transmitted beams being ascertained.

In a further step, the ascertained beam shape, the at least one ascertained dimension, the ascertained position on the detector surface, and/or the ascertained radiation intensity are/is compared to at least one setpoint shape, one setpoint dimension, one setpoint position, and/or one setpoint radiation intensity in order to detect deviations.

In the event of a detected deviation, an impaired functionality of the LIDAR sensor is established. A warning is generated or a calibration is initiated as a response to the impaired functionality.

The impaired functionality may be detected in a targeted manner in the area of the emitting unit and/or of the receiving unit.

According to a further aspect of the present invention, a control unit that is configured to carry out the method according to the present invention is provided. For this purpose, the control unit is preferably connected to a control detector of the LIDAR sensor in a data-conveying manner.

By monitoring the properties of the generated and/or received beams, a long-term functionality of the LIDAR sensor may be ensured while adhering to safety limits for the human eye. Furthermore, errors and deviations due to aging phenomena or damage may be recognized early, thus increasing the reliability of such a LIDAR sensor.

Preferred exemplary embodiments of the present invention are explained in greater detail below with reference to greatly simplified schematic illustrations.

### BRIEF DESCRIPTION OF THE DRAWINGS

FIG. 1 shows a schematic illustration of a LIDAR sensor according to a first specific embodiment of the present invention.

FIG. 2 shows a detailed view of a semitransparent mirror together with a control detector, according to an example embodiment of the present invention.

FIG. 3 shows a schematic illustration of a LIDAR sensor according to a second specific embodiment of the present invention.

FIG. 4 shows a schematic illustration of a LIDAR sensor according to a third specific embodiment of the present invention.

### DETAILED DESCRIPTION OF EXAMPLE EMBODIMENTS

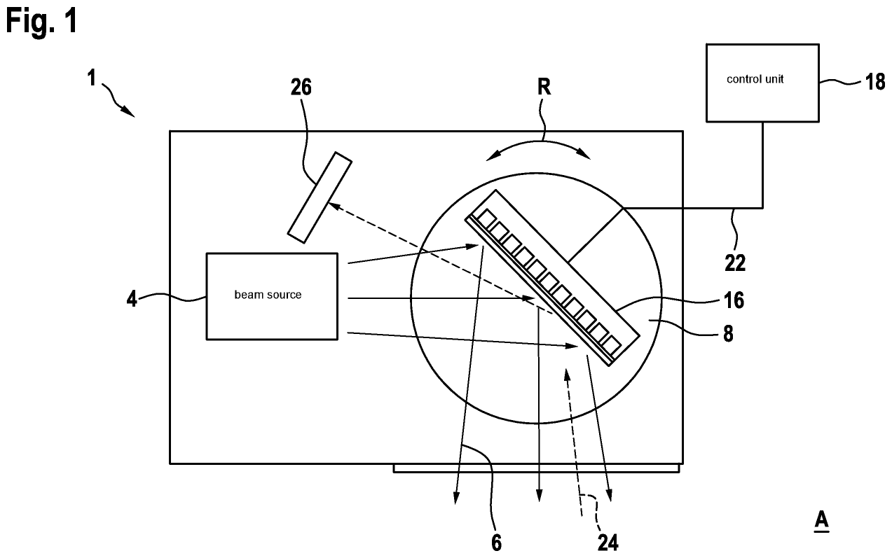

FIG. 1 shows a schematic illustration of a LIDAR sensor 1 according to a first specific embodiment. In particular, a combined emitting unit and receiving unit of LIDAR sensor 1 is illustrated.

LIDAR sensor 1 includes a beam source 4 by way of example for generating electromagnetic beams 6. In the illustrated exemplary embodiment, beam source 4 is designed as an infrared laser and may thus generate beams 6 in an infrared wavelength range. Beam source 4 is stationarily or immovably mounted.

In addition, LIDAR sensor 1 includes a rotor 8 or a rotatable plate. A mirror 10 that may deflect generated beams 6 into a sampling range A is situated on rotor 8. Mirror 10 is designed as a semitransparent mirror, and includes a mirror surface 12 and a rear surface 14 facing away from mirror surface 12. A majority of incoming beams 6 are preferably reflected into sampling range A. A minor portion of generated beams 6 may be transmitted through mirror 10. A portion of generated beams 6 of greater than 90% may be reflected, and a portion of less than 10% may be transmitted through mirror 10.

In the illustrated exemplary embodiment, a control detector 16 is situated at rear surface 14. In particular, control detector 16 may cover or occupy entire rear surface 14 or a portion of rear surface 14 of mirror 10.

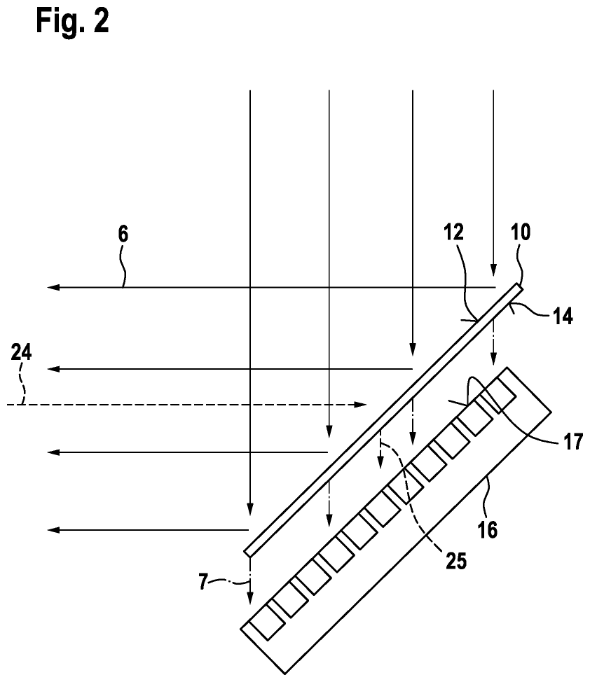

Beams 7 transmitted through mirror 10 are illustrated in FIG. 2, and may be detected by control detector 16. In particular, control detector 16 may generate measured data from received transmitted beams 7 and transfer the measured data to a control unit 18. Control unit 18 may subsequently take on an evaluation of the measured data. In particular, deviations and discrepancies in the optical characteristic of generated beams 6 may be ascertained by evaluating the measured data.

The optical characteristic may encompass, for example, a spatial shape and extent of transmitted beams 7, a position on a detector surface 17 of control detector 16 or on a mirror surface 12, and/or a radiation intensity. Based on the optical properties of mirror 10, the evaluation of transmitted beams 7 may be transferred or applied to generated beams 6.

Setpoint values or a planned optical characteristic may be stored in control unit 18 for detecting deviations or discrepancies. The optical characteristic of generated beams 6, ascertained from the measured data, may be subsequently compared to the planned optical characteristic. Alternatively, the optical characteristic of generated beams 6 may be monitored for changes, without comparative values.

Analogously to generated beams 6, beams 24 that are backscattered or reflected from sampling range A may also be received and evaluated by LIDAR sensor 1. A portion of received beams 24 may be transmitted through mirror 10. Transmitted received beams 25 may likewise be received by control detector 16 and evaluated by control unit 18. Received beams 24 reflected from mirror surface 12 may be subsequently received by a detector or main detector 16 of LIDAR sensor 1 and transformed into measured data, for example to carry out a time-of-flight analysis of generated beams 6.

FIG. 2 illustrates a detailed view of a semitransparent mirror 10 together with a control detector 16. Control detector 16 is spaced apart from mirror 10, and may receive transmitted beams 7 and convert them into electrical signals, which are subsequently available in the form of analog or digital measured data.

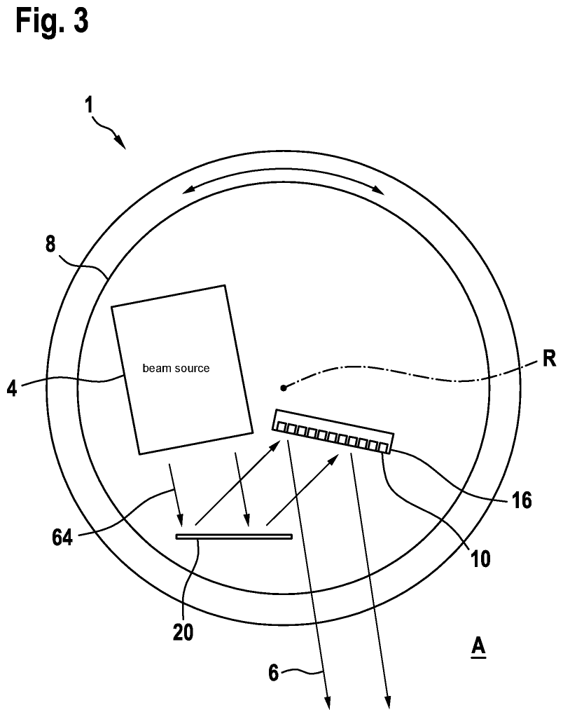

FIG. 3 shows a schematic illustration of a LIDAR sensor 1 according to a second specific embodiment. In contrast to the first exemplary embodiment, in the present case LIDAR sensor 1 includes a beam source 4 that is situated together with mirror 10 on rotor 8. As a result, beam source 4 and mirror 10 are simultaneously swiveled or rotated. Due to the direct mounting of control detector 16 on mirror 10, the control detector is likewise rotated or swiveled on rotor 8. The rotation or swiveling takes place about a rotational axis R of rotor 8.

Generated beams 6 are reflected from an auxiliary mirror 20 onto semitransparent mirror 10. Semitransparent mirror 10 subsequently deflects generated beams 6 into sampling range A.

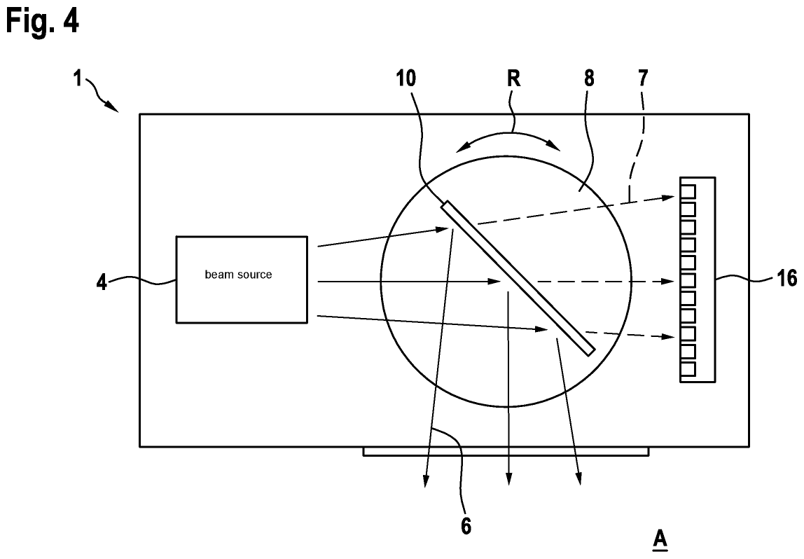

FIG. 4 shows a schematic illustration of a LIDAR sensor 1 according to a third specific embodiment. In contrast to the exemplary embodiments already described, control detector 16 is spaced apart from semitransparent mirror 10. Control detector 16 is fastened stationarily or outside of rotor 8, and thus is not moved relative to mirror 10.

In such an arrangement of control detector 16, an electrical connection 22 between control detector 16 and control unit 18 may have a technically simpler design. In particular, control detector 16 may be connected to control unit 18 in a data-conveying manner without contact brushes or wireless connection technologies.

1-8. (canceled)

9. A LIDAR sensor for sampling a sampling range, comprising:
at least one beam source configured to generate beams;
a detector configured to detect received beams;
at least one immovable or rotatable or swivelable mirror configured to deflect the generated beams at a mirror surface of the mirror into the sampling range or to deflect beams reflected or backscattered from the sampling range to the detector;
wherein the at least one mirror is a semitransparent mirror, and the LIDAR sensor further includes a control detector configured to receive beams that are transmitted through the mirror.

10. The LIDAR sensor as recited in claim 9, wherein the control detector is connected to a control unit in a data-conveying manner.

11. The LIDAR sensor as recited in claim 9, wherein the control detector is situated at a rear surface of the mirror facing away from the mirror surface or is spaced apart from the rear surface.

12. The LIDAR sensor as recited in claim 11, wherein the control detector, which is spaced apart from the rear surface of the mirror, is stationarily mounted.

13. The LIDAR sensor as recited in claim 9, wherein the control detector is configured to ascertain measured data about a beam shape and/or a position on a detector surface and/or a radiation intensity, of the beams transmitted through the mirror.

14. The LIDAR sensor as recited in claim 13, wherein the control detector is configured to record the measured data over a period of time in a time-resolved manner.

15. A method for checking a functionality of a LIDAR sensor by a control unit, the method comprising the following steps:
receiving measured data, ascertained by a control detector, of beams transmitted through a semitransparent mirror;
ascertaining a beam shape and/or a position on a detector surface of the control detector or on a mirror surface and/or a radiation intensity of the transmitted beams, by evaluating the measured data;
comparing the ascertained beam shape and/or the ascertained position on the detector surface and/or the ascertained radiation intensity, to at least one setpoint shape and/or setpoint position and/or setpoint radiation intensity, to detect deviations; and
based on detecting a deviation, (i) establishing an impaired functionality of the LIDAR sensor, and (ii) generating a warning or initiating a calibration.

16. A control unit configured to check a functionality of a LIDAR sensor, the control unit configured to:
receive measured data, ascertained by a control detector, of beams transmitted through a semitransparent mirror;
ascertain a beam shape and/or a position on a detector surface of the control detector or on a mirror surface and/or a radiation intensity of the transmitted beams, by evaluating the measured data;
compare the ascertained beam shape and/or the ascertained position on the detector surface and/or the ascertained radiation intensity, to at least one setpoint shape and/or setpoint position and/or setpoint radiation intensity, to detect deviations; and
based on detecting a deviation, (i) establish an impaired functionality of the LIDAR sensor, and (ii) generate a warning or initiate a calibration.
